(19) United States
(12) Patent Application Publication
(10) Pub. No.: US 2012/0221345 A1
(43) Pub. Date: Aug. 30, 2012

(54) HELPING PEOPLE WITH THEIR HEALTH

(76) Inventors: Douglas J. McClure, Framingham, MA (US); Frederick C. Lee, Annandale, VA (US); Mary Beth Chalk, Austin, TX (US); Catherine A. Hartman, Hingham, MA (US); Arnold J. Greenfield, Chestnut Hill, MA (US); Elizabeth M. Barbeau, Needham, MA (US); Martin D. Adler, Wayland, MA (US); Christopher Pilkington, Wayland, MA (US); Jason J. Sroka, Lunenburg, MA (US); Robert A. MacWilliams, Auburndale, MA (US)

(21) Appl. No.: 13/033,642

(22) Filed: Feb. 24, 2011

(51) Int. Cl. G06Q 50/00

(52) U.S. Cl. 705/2

(57) ABSTRACT

Among other things, a method includes, on successive occasions over a period of time, gathering measured data and self-reported data that represent a health state of a particular participant in a health goal system, using the gathered data in a machine learning engine to select, for a current occasion, a current intervention to be self-applied by the particular participant, the machine learning engine having learned from data gathered from a group of participants on successive occasions, the effectiveness of sequences of self-applied interventions in improving the health states of participants who belong to respective groups that share similar characteristics, the current intervention being expected to affect, for the particular participant (i) a behavior, (ii) the health state, or (iii) a health awareness, and providing the particular participant, electronically through a user interface, information that will encourage the particular participant to engage in the selected self-applied current intervention.

### BACKGROUND

This description relates to helping people with their health.

People can be helped with their health, for example, to maintain or improve it or slow down its decline using communication methods such as email, text messaging, social networking feeds, and others ways of communicating through laptops, smartphones, tablet computers, and other network connected hardware. These communication methods can provide information to a person in real time throughout the day including health related information that may be useful to the person in achieving a health-related goal.

### SUMMARY

In general, in an aspect, a method includes on successive occasions over a period of time, gathering measured data and self-reported data that represent a health state of a particular participant in a health goal system, using the gathered data in a machine learning engine to select, for a current occasion, a current intervention to be self-applied by the particular participant, the machine learning engine having learned from data gathered from a group of participants on successive occasions, the effectiveness of sequences of self-applied interventions in improving the health states of participants who belong to respective groups that share similar characteristics, the current intervention being expected to affect, for the particular participant (i) a behavior, (ii) the health state, or (iii) a health awareness, and providing the particular participant, electronically through a user interface, information that will encourage the particular participant to engage in the selected self-applied current intervention.

In general, in an aspect, a method includes providing a participant, electronically through a user interface, intervention messages that will encourage the particular participant to engage in a selected self-applied current intervention, the messages based on data gathered from a group of participants on successive occasions, the data indicating the effectiveness of sequences of self-applied interventions in improving the health states of participants who belong to respective groups that share similar characteristics.

In general, in an aspect, a method includes using a machine learning engine to select, for a current occasion, a current intervention to be self-applied by the particular participant, the machine learning engine having learned from data gathered from a group of participants on successive occasions, effectiveness of sequences of self-applied interventions in improving health states of participants who belong to respective groups that share similar characteristics, the current intervention being expected to affect, for the particular participant (i) a behavior, (ii) the health state, or (iii) an health awareness.

These and other aspects and features, and combinations of them, may be expressed as apparatus, methods, systems, and in other ways.

Implementations may include one or more of the following features.

The implementation may also include identifying that a required input in the gathered data is absent and taking an action if a predictive model requires a range of input values that are not available for the particular participant.

Taking an action may include posing a question to the particular participant to solicit a response and complete the required input.

Taking an action may include taking a measurement of the particular participant to complete the required input.

The current intervention may be selected independent of a specific instantiation of an interaction associated with the capabilities and limitations of a specific device.

The information may be retrieved from a content library storing at least one of text, audio, and video.

A content library may contain a reference to a specific media item and a corresponding reference to an external resource capable of providing the media item to the participant.

The implementation may include determining a set of enrollment questions to present to the particular participant to determine the health and wellness goals for the participant.

Other features and advantages will be apparent from the description and the claims.

### DESCRIPTION

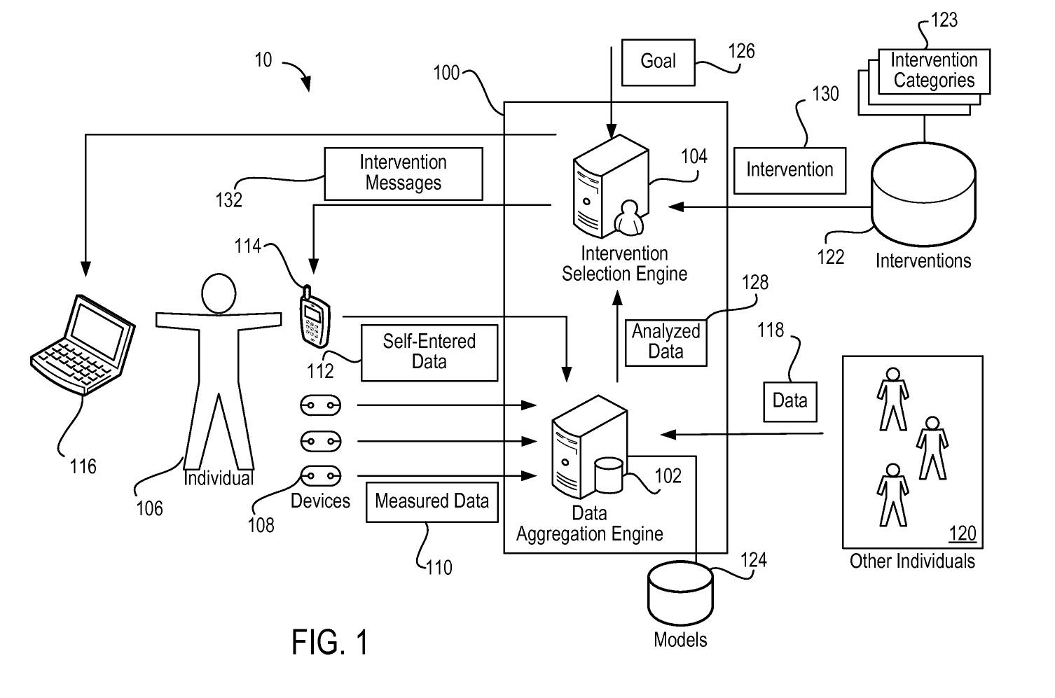

FIG. 1 shows a health system.

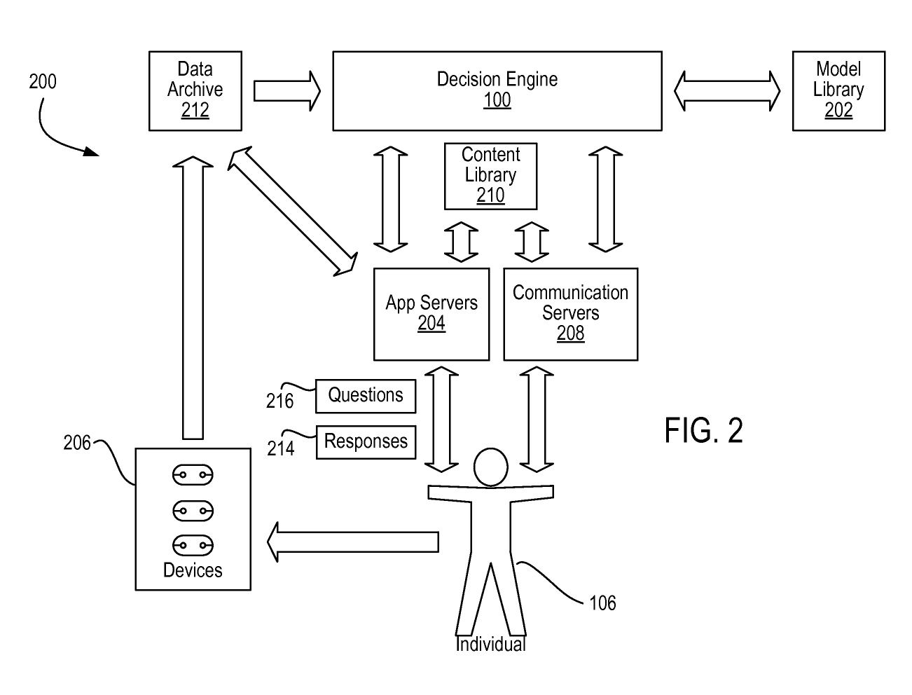

FIG. 2 shows a system architecture.

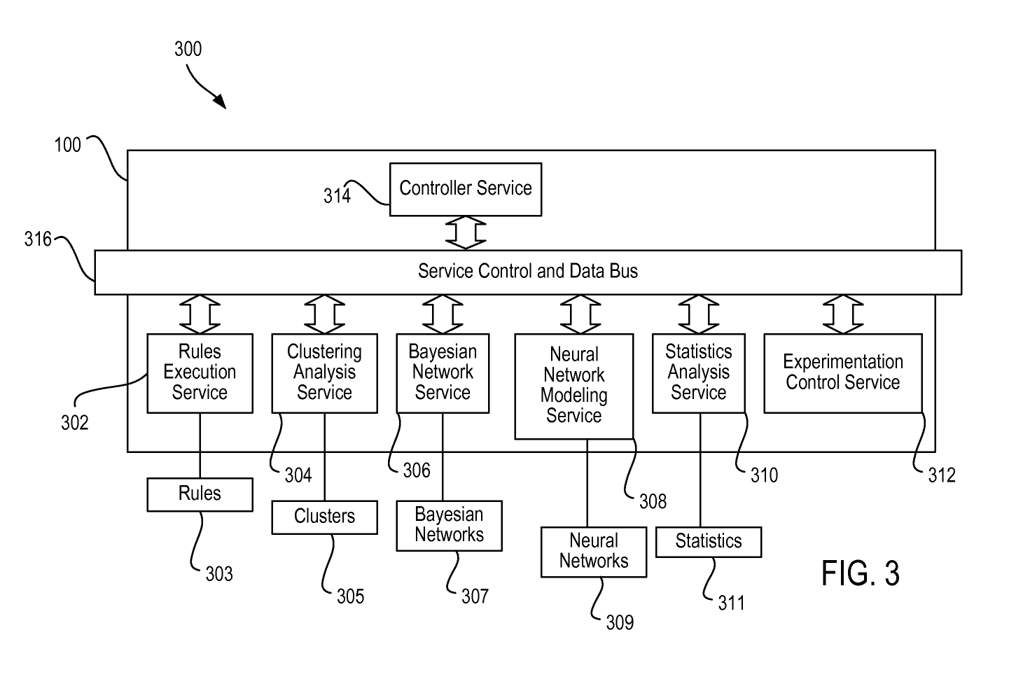

FIG. 3 shows a software architecture.

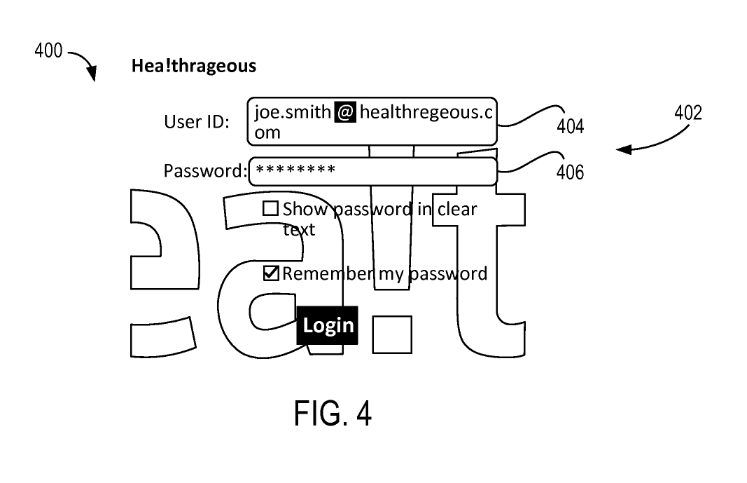

FIG. 4 through FIG. 9 show user interfaces.

The techniques that we describe here are meant to help people individually with maintaining, improving, or slowing a decline of a state of their health. Typically, in what we describe here, a person has a goal (or more than one goal) for maintaining, improving, or slowing the decline of a state of his or her health. We call this a health goal. When we refer to a personal “health goal,” we include, for example, one or more criteria to be achieved with respect to the individual's health. A health goal can be, for example, a value or range of values of a measurable parameter (for example blood pressure) at one point in time or over a period of time. Non-measurable health states can also be health goals, for example, being able to exercise more with less pain. A health goal can have a final state to be achieved, such as a desired blood pressure level or desired blood triglyceride level, or can be an ongoing state, such as a minimum number of steps taken per week indefinitely. In general, a health goal, in the way we use the term is something that will not be achieved unless the individual changes her conduct in some way, compared to what it otherwise would be, in order to achieve the health goal. We broadly refer to the changes in conduct as interventions or individual interventions. Therefore, any intervention includes, for example, any action or behavior that an individual engages in or refrains from in order to reach a health goal. The intervention may be one that is conscious (for example, that the individual consciously increases the number of glasses of water consumed in a day) or unconscious (for example, that the individual unconsciously increases body hydration by eating more fruit). A variety of other kinds of health goals and combinations of them can be addressed by the techniques described here.

The techniques that we describe here include, for example, helping individuals to undertake interventions to reach their health goals.

Among other things, in some examples described here, an intervention is varied with respect to a particular health goal or goals. The variation is arranged over time or from time to time or only once. Changes in the measured parameters or healthcare technology or knowledge or changes in the goal or subjective information provided by the individual (and possibly a wide variety of other factors) can be used as the basis for determining how to vary an intervention to achieve a goal. In general, an individual is thought to be more likely to achieve a health goal if an intervention is adapted over time and is personalized to the individual.

The techniques that we describe here aim to cause individuals to engage in interventions to reach their health goals by communicating with them from time to time. We call these communications, in general, intervention messages. Intervention messages can take a very broad range of forms, can occur in a very broad range of times, can use a very broad range of communication media, and can be delivered through a very broad range of platforms.

As shown in FIG. 1, a health goal system 10 (also referred to as simply the “system”) is operated, among other things, to help a potentially very large number of people 106, 120 to reach specified health goals 126 using interventions 130 that are prompted by intervention messages 132. In addition to helping people with their health goals, the system can be used for a wide variety of other purposes, including the following: to reduce the cost of providing health care; to reduce the cost of insuring health care services and of paying for such insurance; to improve the services and benefits provided by employers and other institutions for people associated with them; to generate revenue as part of the operation of the system; to provide an advertising platform; to accumulate and study data that represents health states of people; interventions attempted over time to help people reach health goals; the results of the interventions, and related demographic information about the people, among other things; and to provide information to other systems about interventions, intervention messages, results, and their relationships to health states of people, for a variety of uses; and to interact with other websites including social networking sites, search sites, and others.

System 10 includes a data aggregation engine 102 that collects data from multiple sources associated with multiple individuals and also includes an intervention selection engine 104 that uses the collected data to determine an intervention (for example, an intervention that is considered to be most likely to succeed) to be applied to an individual 106. Together, in some implementations, the data aggregation engine 102 and intervention selection engine 104 use machine learning to determine an appropriate intervention for a target individual 106 given the data available at a point in time. We sometimes refer to the combination of the data aggregation engine 102 and intervention selection engine 104 as the decision engine 100), and to the determinations that it makes regarding interventions as decisions.

The decision engine 100 analyzes data and generates control decisions for other system elements, and serves as the central controller for how the health system interacts with individuals (we sometimes refer to as participants). As data becomes available about participants, the decision engine 100 can take advantage of the data to tailor its interactions with a given participant. Two approaches to tailoring are the selection of interventions that are expected to achieve a particular health goal and the generation of data allowing examination of which interventions work best for different types of participants. For example, participants can be assigned to groups that have different characteristics to explore which interventions lead to better results with respect to respective groups. In some examples, a participant may be assigned to a group according to the participant's age to evaluate whether interventions associated with an age group are appropriate for the participant, and the participant may also be assigned (at the same time or at a different time) to a group according to the participant's gender to evaluate whether interventions associated with gender are appropriate for the participant.

While the data aggregation engine 102 and intervention selection engine 104 are represented in FIG. 1 as discrete components, they need not be coherent structures such as software programs or network servers. The data aggregation engine 102 and intervention selection engine 104 can each be made up of multiple software and/or hardware components, and both engines can themselves be part of a single unit, for example, software running on a computer system or cluster of servers.

The data aggregation engine 102 performs a wide variety of data collection activities. For example, it collects data about an individual 106 indicative of a health state of the individual. One type of data collected can be data measured by an electronic device 108 such as a pedometer, blood pressure cuff, glucose monitor, sleep monitor, or any other kind of device that could be used to collect data. This measured data 110 can include meta-data, such as the location and time at which the data was collected. Another type of collected data can be data 112 that is self-entered by the individual 106, including quantitative information such as amount of foods eaten or hours slept as well as qualitative information such as self-perception of mood or stress level. The self-entered data 112 can include data evaluating the intervention, such as an indication by the individual that he likes or does not like the intervention, or an impression by the individual that the intervention is working well or not. The data can be entered electronically on a mobile device 114 such as a smart phone or another type of electronic device 116 such as a computer, for example. The collected data can include a very wide variety of data, including any data that is indicative of, a measure of, or related to any aspect of the individual's condition, motivation, or feeling that bears on a state of the individual's health, interventions, intervention messages, or health goals. The sources of the collected data can vary widely and include any kind of device, hardware, platform, system, software, or other instrument that can provide such data.

In addition to collecting data from an individual for whom the system is to provide interventions to help the individual reach a health goal, the data aggregation engine 102 can collect data 118 (measured and/or self-entered) from many other individuals 120 and use the collected information to determine what types of interventions (and sequences of interventions) succeed for a particular individual, and also what types of interventions (and sequences of interventions) are likely to succeed for a category or group of individuals. The data aggregation engine 102 does this by analyzing the data in an ongoing fashion to find patterns of success and failure for different types of interventions 122 (and sequences of them). The data aggregation engine 102 can also examine patterns among multiple individuals to categorize individuals into one or more categories of individuals who may respond similarly to similar kinds of interventions 122 (and sequences of them).

Generally, any individual has several characteristics that define the individual. Characteristics can include physical characteristics such as the individual's age, height, weight, and gender, and characteristics can also include other types of information potentially relevant to health, such as whether the individual smokes and whether the individual has a dangerous occupation.

The other individuals from whom or with respect to how data may be collected may include individuals for whom the system is selecting and providing interventions and intervention messages as part of its normal operation. The other individuals may also include people who are not active participants in the system.

The intervention selection engine 104 chooses one or more interventions 122 (or sequences of them) to apply to a target individual 106 participating in the health goal system 10. A wide variety of inputs can be used by the intervention selection engine 104 in making such choices.

One input that the intervention selection engine 104 uses to make choices is one or more health goals 126. Each health goal 126 can be selected by the target individual 106, for example, or another entity such as the target individual's doctor. Another input is analyzed data 128 provided by the data aggregation engine 102, including data based on data 110, 112 collected from the target individual 106 and data 118 collected from other individuals 120.

Other inputs could include data derived from research, hypotheses about interventions that may be effective, interventions proposed by third party vendors or partners of a host of the system, and others.

The intervention selection engine 104 uses the health goal or goals 126 (which we sometimes refer to simply as the goal) to select an intervention 130 (or multiple interventions or a sequence or sequences of the interventions) appropriate for that goal, and uses the analyzed data 128 to choose intervention messages to be sent to the individual to cause or attempt to cause the interventions to occur.

Generally, the interventions 122 can include intervention categories 123 from which to choose. An intervention category is a type of intervention (for example, attempting to reduce the intake of caffeine) to which multiple interventions can belong. The particular intervention 130 chosen from among the intervention categories 123 represents a particular set of actions that can be carried out to achieve the desired result of the intervention category 123 of the intervention 130. For example, the particular intervention 130 could be attempting to get the participant to drink less coffee by making suggestions to drink less coffee in the morning, as opposed to the evening during which the participant is unlikely to be drinking any coffee.

An intervention 130 to change a target individual's behavior may be executed by sending intervention messages 132 to the target individual 106 regularly. For example, each morning the individual could be prompted to reduce your intake of caffeine from three cups of coffee to one cup. The analyzed data 128 may indicate approaches that have had success for the target individual 106, or approaches that have had success for individuals similar to the target individual for the same health goal 126. This may mean sending messages more frequently, less frequently, more sternly worded, less sternly worded, and so on. This may also mean planning intervention messages to be provided in the short-term for the target individual 106, or planning intervention messages to be provided over a long-term for the individual. These alternatives can be characterized as features of a generic intervention, and the analyzed data 128 allows the intervention selection engine 104 to choose the best features after choosing an intervention 130. The intervention messages 132 can be sent to the target individual 106 in any number of formats and using any number of channels. For example, the intervention messages 132 can be sent to a mobile device 114 or another kind of electronic device 116 used by the target individual 106. Virtually any kind of intervention message and any mode of delivering the intervention message that has a prospect of succeeding in the intervention and helping the individual to reaching the health goal could be used.

The data aggregation engine 102 and intervention selection engine 104 use machine learning to identify interventions and intervention messages to apply to a target individual. We use the term “machine learning” in a broad sense to include for example, any approach in which a computer system develops a store of data that can be applied to algorithms that improve as more or better data becomes available. For example, an algorithm that accomplishes a particular computational task may perform that task more efficiently or with more accurate or more precise results as the associated computer system receives (or “learns”) more data.

The data aggregation engine 102 is the component of the decision engine 100 tasked with “learning” based on the data received. The data aggregation engine 102 does this by generating decision models 124, which are descriptions of the expected behavior of elements that interact with the decision engine 100. The decision models 124 are generated based on an analysis of the data received. For example, some decision models 124 could describe how different participants may behave when certain interventions are applied to them. These decision models 124 may be tailored to a particular category of participant, such as participants of a certain age group, gender, or other characteristics of the participant.

The decision engine 100 uses machine learning to tailor interactions with a participant (that is, selects appropriate intervention and appropriate intervention messages) in order to achieve one or more particular health goals. The decision models 124 can be based on externally-provided control logic (e.g., expert systems) or developed based on analysis of historic participant interactions (e.g., neural networks) or hybrids of these types of approaches are used when multiple options for interacting with a participant are available, to determine which of the multiple options is best matched with the participant. Further, the decision engine 100 can automatically initiate the creation, updating, and exploitation of decision models 124 used in the decision-making process as well as to make control decisions in order to generate data that supports the training, testing, and validation of the decision models 124.

One approach to model generation uses data (e.g., historic data) from participants (e.g., past participants) to train decision models 124 that then attempt to predict which interaction options (our reference to interaction options includes, for example interventions and intervention communications) that may have a chance of contributing to achieving a goal. In this situation, existing data is analyzed to determine how accurate one or more participant characteristics can be in predicting the likelihood of an interaction option contributing to a successful outcome. Data from historic participants is combined with information about measured outcomes (for example, whether or not a participant achieved a goal that was the focus of an intervention), and a model such as an artificial neural network trained to then be able to predict which participants will demonstrate which levels of success. If the model can achieve a threshold level of validation, it will then be made available for use in future decisions. For example, if a model can be used to identify an intervention that achieves associated health goals, and does so for a certain percentage of participants a certain percentage of time, the model can be deemed “valid.”

Another approach, useful in conditions where limited amounts of historic data are available, is to use a clustering technique which entails assigning participants exposed to similar interaction options into two or more groups (“clusters”) based on their outcomes. This has the advantage of identifying a set of characteristics of participants that may predict whether or not a particular participant will be successful given the interaction option. Statistical analysis of historic results can then be used to evaluate if the data shows a significant difference between two or more clusters, or even a tendency that does not yet achieve significance. In cases where a statistically significant difference is seen, the clusters are made available for use in future decision-making Where a potentially significant result is obtained, the system can identify what additional information is needed in order to better evaluate the statistical significance and then implement steps to collect that data, for example by assigning future participants to interaction options in order to complete a set of data points. As this additional information is made available, it is automatically evaluated to determine if it calls for an update to the models available for use in future decisions.

The system's ability to automatically determine how to address data gaps and enable more effective evaluation of participant characteristics' predictive capabilities can make it increasingly capable as it is used by ever larger numbers of participants. Existing data may not have been collected in such a manner to allow a statistically significant result to be achieved, for example because the number of participants sharing a set of characteristics is not large enough to provide a statistically significant sampling. The system can assign future participant interactions in a way that addresses data deficiencies and adapts to participant responses as they happen, responding to conditions such as participant dropout and additional participant enrollments. Alternatively, if the predictive model requires a range of input values that are not available for a particular participant (e.g. answers to a set of question about activity and diet), the system can identify that a required input is lacking and take an action (e.g. posing the question to the participant to solicit the response and complete the required input data or requesting the participant take a measurement).

In addition, the system can adapt future interactions based on the evolving evaluation of efficacy, e.g. if a statistically significant predictive capability of a participant characteristic for determining that a particular interaction is effective is found, further experimentation can be curtailed so that all future participants (or an increased proportion) are assigned the feature in response to their exhibiting the participant characteristic(s). Another type of data deficiency that can be addressed is the lack of specific input characteristics for a set of participants. This can happen, for example, when one population of participants does not answer the same set of enrollment questions as another population. If one or more of these enrollment questions are found accurate in predicting the efficacy of an interaction, the question(s) can be added to the interactions that will be executed for those participants, so that participants' responses are then available in determining who will be exposed to the feature.

FIG. 2 shows a system architecture 200 demonstrating how the decision engine 100 uses available resources to interact with a target individual 106 (participant).

The model library 202 contains parameters of models used by the decision engine 100 in the process of generating control decisions or of analyzing participants and groups of system participants, as well as the models themselves. The models can be the decision models 124 shown in FIG. 1, for example. Models that are applicable to the general participant population are stored together with participant-, cluster-, or population-specific models that incorporate information about the specific participant/cluster/population that it will used for.

App servers 204 (application servers) generate the content that allows web browsers, mobile devices, and other software and hardware to interact with participants of the system. The content represents the actual information that the participants views, reads, and otherwise interacts with including, for example, intervention messages 132 shown in FIG. 1. As an example, a participant may interact with a web application to complete an initial health survey, or with a mobile application to record an activity they engaged in, or be prompted by a medical device to take a biometric reading. The app servers 204 component of the system allows decisions about how to communicate with participants and the goals of an intervention to be handled separately from the communication capabilities and limitations of a specific device. In this way, the system is “device agnostic”—the core functionality of the system can work with any of several kinds of devices, includes devices not yet known when the system begins operation. The content, or messages, could contain text, audio, video, animations, or some combination of these, depending on the capabilities of a device being used to receive the content.

A wide range of biometric sensor devices 206 can produce measurements and data that contribute to characterizing and understanding the health of a target participant. Measurements from a range of devices will be accepted by the system and used as the basis of decisions about how to interact with the target participant, both in identifying optimal interaction approaches and in establishing target health and wellness goals and strategies. Data from devices may be accessed directly or through one or more intermediary steps. For example, a data hub in a home can collect information from multiple devices and publish it to a database (for example, the data archive described below) that the data aggregation engine can then access through the Internet.

To accommodate the range electronic communication methods that target participants may use in their work and private lives, a communication servers 208 component of the system allows a single message to be delivered in any (or multiple) of a wide variety of communication modalities including but not limited to email, voicemail, text messages (SMS), a twitter feed, messages generated in and/or delivered through social network services, etc. The communication servers 208 component is also extensible, enabling the health system to incorporate additional communication modalities and opportunities that may become available.

The content library 210 is a repository of health and wellness information and media that is available for the system to present to participants. Content can include different media types (e.g. text, audio, audiovisual) and can be stored as media in the content library 210 or the content library 210 can serve as a mediator between a system-internal reference to a specific media item with an external resource (e.g. one of the communication servers such as a web server) that can provide the media item to the system or to a participant.

The data archive 212 stores information about participants and populations. Biometric measured data collected by devices (e.g., pedometer readings over time), historic information about interactions that occurred (e.g., history of when a participant has logged into the system or otherwise used the system), and participant responses 214 to questions 216 (e.g. responses to a set of questions posed in an enrollment questionnaire) are stored in the data archive 212 and made available to other system components. In addition to raw data, processed and summarized data can be stored (for example, the analyzed data 128 shown in FIG. 1). As an example, participant pedometer readings collected each hour can over time be replaced in the data archive 212 with summarized information like overall steps per day or week or even longer periods of time. The data archive 212 covers the functionality of online-accessible data resources, e.g. digital records accessed from a professional health care office.

FIG. 3 shows a software architecture 300 that can be used to implement the decision engine 100, including services used by the decision engine.

A rules execution service 302 can execute one or more rules 303 expressed in terms of “If <condition> then <action>”, implementing what are also referred to as “Expert Systems”. The rules execution service can allow for the creation and editing of a set of rules 303 as well as the evaluation of the correct action to take given a specific scenario.

A clustering analysis service 304 can implement one or more clustering techniques, e.g. k-means clustering, to assign participants to a particular cluster or group of participants based on similarity with other members across the range of possible characteristics of participants. The number of clusters 305 (groupings of participants) can be pre-determined or an adaptive version of the algorithm used that adjusts the number of overall clusters based on criteria such as minimum number of members in a cluster or a metric reflecting the similarity of members of the cluster 305.

A Bayesian network service 306 can allow partial knowledge or beliefs about a domain to be captured in a probabilistic model/framework and then used to make decisions. Incorporation of Bayesian networks 307 (a type of decision model) as a decision-making approach allows the system to leverage domain knowledge and expert hypotheses about potential causal and correlation relationships between participant characteristics and between participant characteristics and outcomes without requiring codification of a set of strict “if . . . then” statements. Further, the Bayesian framework allows decision models that begin with expert-generated parameter values to be updated based on long-term data collections, merging expert-provided with data-driven parameter evaluations. Because Bayesian networks 307 are robust to incomplete input data sets, which is the condition we expect to be prevalent given the overlapping input information we have about participants, the use of Bayesian networks 307 as decision models can be one of the main machine learning techniques used by the system.

A neural network service 308 can use techniques, e.g. backpropagation-trained feed-forward artificial neural networks 309 and also use outcome information to automatically generate a mapping from a multi-dimensional input feature space to a decision (e.g. the extent to which a feature should be exposed to a participant). Neural networks 309 can be used where a set of outcome categories (e.g. successful engagement, unsuccessful engagement) can be associated with a set of participant outcomes and where the goal is then to determine how to effectively map from known participant characteristics to a decision about how to interact with the participant.

A statistical analysis service 310 can provide access to higher-level statistical analysis of a participant's data or of data over a population or other grouping (“cluster”) of participants sharing characteristics. Within the decision engine, the statistical analysis service 310 will be used for simple tasks like generating common statistics 311 of groups of data (e.g. to determine an average daily step count from hourly step data) to complex things like determining if the distributions of results values across two groups of participants belies a statistically significant difference.

An experimentation control service 312 can implement the evaluation of data sets at all stages of the model generation, testing, and validation stages. It is capable of evaluating models based purely on historic data or of evaluating data sets to determine how they should best be augmented to improve the ability to evaluate a decision model (e.g. through directed data collection).

A decision engine controller service 314 can coordinate the activities of the other decision engine services to realize the higher-level functionality for automatically adapting how the system interacts with participants, groups, and populations, over time. Coordination functions can themselves rely on decision engine services to implement, for example having a rules-based system define the criteria for initiating model creation and experimentation on a new population of participants.

The service control and data bus 316 is a common communication facility that all participant services can use to receive commands and to send responses. For example, the service control and data bus 316 can use a “publish/subscribe” methodology whereby services announce their presence and can optionally report their capabilities. The service then “subscribes” to a queue instantiated to hold control messages for the services and receives data from the queue. Other system components or other services within the decision engine 100 can “publish” commands/requests to the queue when functionality delivered by the service is needed. The commands/requests are then delivered to the subscribers.

The health system allows for health applications to be applied to participant populations associated with groups such as employer health plans and private organizations that may have overlapping functionality. For example, the participant populations may have available multiple types of online and mobile applications and access to and use of different types of biometric sensors and devices. Interaction options can be low-level details (for example, which among several possible educational health and wellness tips a participant should be presented with) to high-level decisions (for example, which of a set of weight management strategies to suggest to a participant). As new populations of participants are enrolled with the system, the system's decision engine determines the set of questions each participant will be presented as part of their enrollment. Answers to enrollment questions will also be used to determine both the health and wellness goals for the participant (e.g. daily target step counts) as well as decisions about how best to interact with the participant (e.g. which communication channels to rely on most heavily, what tone to use in communications, etc.).

The participants using the system can have multiple ways of accessing the system, e.g. through a web browser application or through a smart phone application. Each time the participant logs in to such an application or otherwise interacts with the system, the system can update the set of information available about the participant and make decisions that impact the current interaction. As an example, a health tip can be identified that is relevant to the recent activity of the participant or to an aspect of their health and wellness goal(s), or a question can be posed in order to complete the information needed about the participant to support a background model evaluation.

As a participant uses the health goal system, the system can adapt its interactions with the participants to improve their satisfaction and the results they will realize in using the system. The timing and modality of communications can adapt to the patterns of the participant, or models that have been tailored by recent data at the population level applied to the participant to make it more likely their health goal(s) will be achieved.

FIG. 4 shows an example of a log-in interface 400 appearing on a mobile device that interacts with the health system. The log-in interface 400 allows a participant to enter user credentials 402, for example, a user ID 404 and a password 406, to gain access to data made available by the health system.

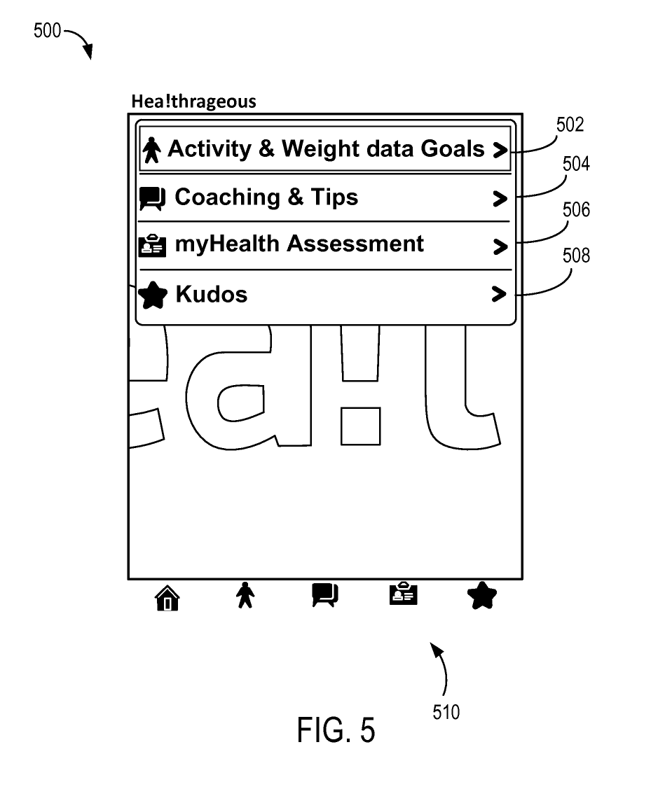

FIG. 5 shows an example of a home screen interface 500 presented to a participant on a mobile device. The home screen interface 500 allows a participant to access resources of the health system. An Activity & Weight Data Goals button 502 provides the participant with information about the participant's progress on health goals. A Coaching & Tips button 504 provides the participant with guidance on how to further his progress in achieving a health goal. A myHealth Assessment button 506 provides the participant to provide feedback about his health to the system. A Kudos button 508 provides the participant with a list of “kudos,” which are awards representing health-related milestones that the participant has achieved. The home screen interface 500 also has other buttons 510 that provide access to other elements of the system.

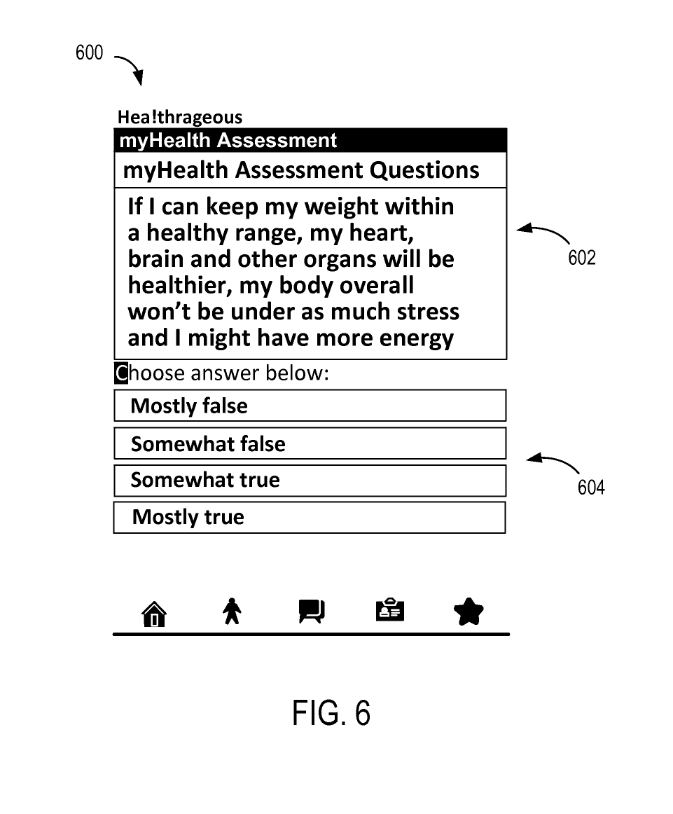

FIG. 6 shows an example of an assessment interface 600 that can be accessed using the myHealth Assessment button 506 (FIG. 5). Here, the assessment interface 600 displays an assessment question 602. The assessment question 602 is presented to the participant to determine information about the participant based on the response. For example, the assessment question 602 presented in FIG. 6 asks the participant a question about the relationship between body weight and well-being. The participant is prompted to provide an answer 604 from a list of multiple choices. Here, the participant's answer can be used by the system to assess the participant's understanding of the topic of health.

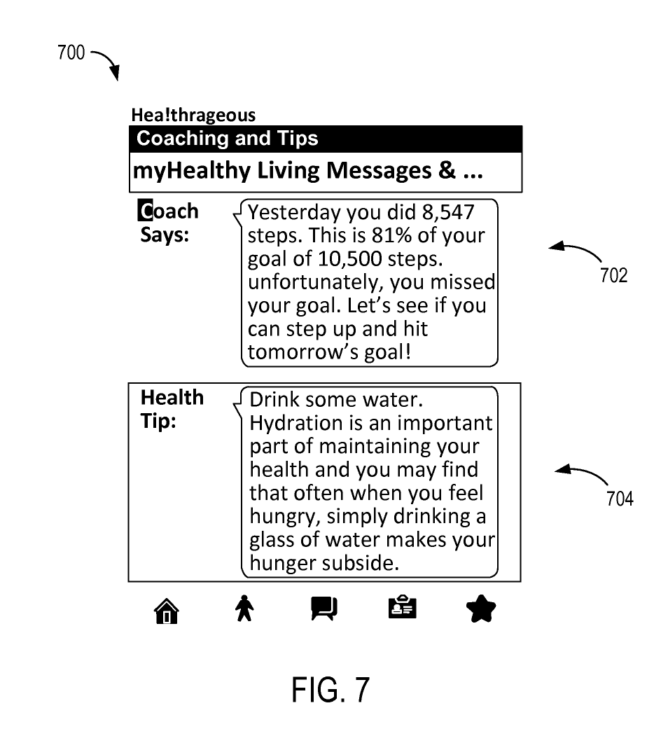

FIG. 7 shows an example of a messages interface 700 that can be accessed using the Coaching & Tips button 504 (FIG. 5). The messages interface 700 provides feedback to the participant, for example, based on information about the participant available to the health system and based on one or more interventions applied to the participant. For example, the feedback can be the intervention messages 132 (FIG. 1). The messages interface 700 may display coaching tips 702 which provide the participant with feedback specific to the participant, for example, information about the participant's progress toward a health goal. The messages interface 700 may display health tips 704 which can be recommendations specific to a participant, specific to an intervention, or general recommendations applicable to any human being. Multiple coaching tips 702 and health tips 704 can be displayed, and the coaching tips 702 and health tips 704 can be chosen based on multiple interventions. For example, if a participant is receiving an intervention related to weight loss, and the participant is also receiving an intervention related to triglyceride reduction, a coaching tip 702 or health tip 704 may be displayed regarding the participant's sugar intake.

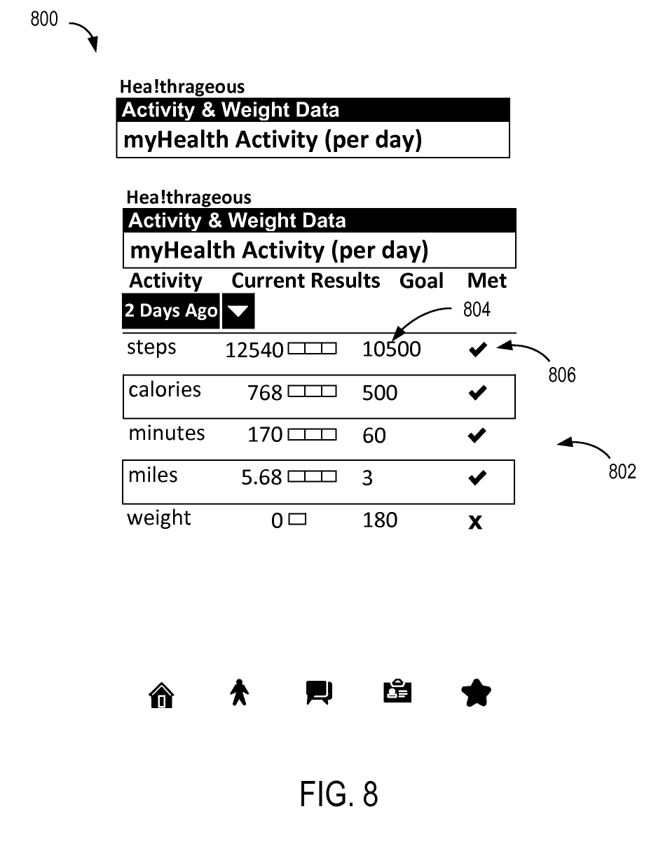

FIG. 8 shows an example of a statistics interface 800 that can be accessed using the Activity & Weight Data Goals button 502 (FIG. 5). The statistics interface 800 provides a participant with statistical data 802 relating to the participant's vital signs and health-related activities, for example, number of steps taken, calories consumed, minutes of exercise, distance walked, and the participant's body weight. The statistics interface 800 can include information about how the statistical data 802 related to the participant's health goals, for example, target values 804 and a determination of whether or not the participant is achieving the target values 806.

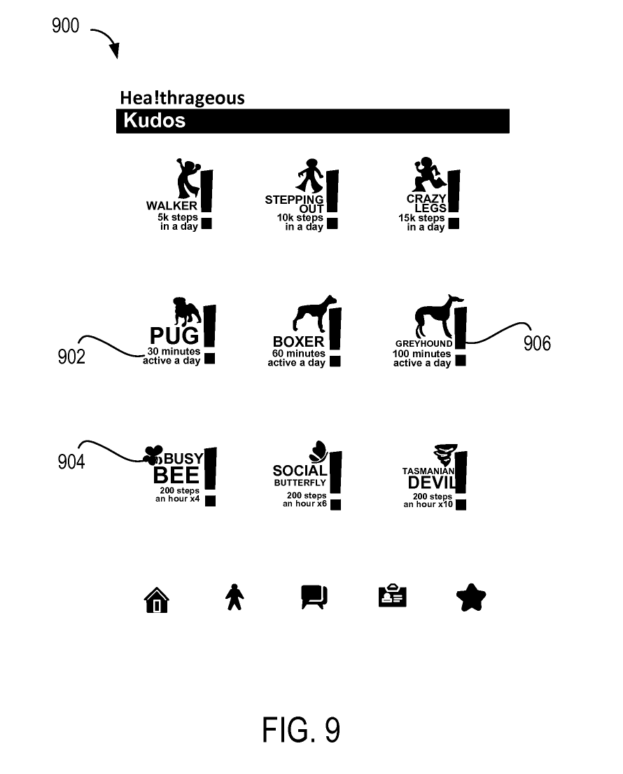

FIG. 9 shows an example of a milestones interface 900 that can be accessed using the Kudos button 508 (FIG. 5). The milestones interface provides the participant with a list of “kudos,” which are awards representing health-related milestones that the participant has achieved. For example, a participant who has remained active for at least thirty minutes a day and has walked two hundred steps within an hour may be awarded corresponding kudos 902, 904. The participant can also be presented with kudos 906 that have yet to be achieved to motivate the user to seek out the corresponding activities and achieve further milestones.

The interfaces shown in FIGS. 4 through 9 include examples of interventions that may be applied to a participant. These examples are not comprehensive and they demonstrate only a subset of many ways in which interventions can be used within the health goal system.

Although an example health goal system has been described in FIG. 1 as using computer systems and mobile devices, for example, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as software for processing health data or communicating intervention messages, can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, a composition of matter effecting a machine readable propagated signal, or a combination of one or more of them.

The term “system” may encompass all apparatus, devices, and machines for processing data, including by way of example a programmable processor, a computer, or multiple processors or computers. The processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

Implementations can include a back end component, e.g., a data server, or a middleware component, e.g., an application server, or a front end component, e.g., a client computer having a graphical user interface or a Web browser through which a user can interact with an implementation of the subject matter described is this specification, or any combination of one or more such back end, middleware, or front end components. The components of the health goal system can be interconnected by any form or medium of digital data communication, e.g., a communication network. Examples of communication networks include a local area network (“LAN”) and a wide area network (“WAN”), e.g., the Internet.

Other implementations are within the scope of the following claims.

1. A method comprising
on successive occasions over a period of time, gathering measured data and self-reported data that represent a health state of a particular participant in a health goal system,
using the gathered data in a machine learning engine to select, for a current occasion, a current intervention to be self-applied by the particular participant,
the machine learning engine having learned from data gathered from a group of participants on successive occasions, effectiveness of sequences of self-applied interventions in improving the health states of participants who belong to respective groups that share similar characteristics,
the current intervention being expected to affect, for the particular participant (i) a behavior, (ii) the health state, or (iii) a health awareness, and
providing the particular participant, electronically through a user interface, information that will encourage the particular participant to engage in the selected self-applied current intervention.

2. The method of claim 1 further comprising identifying that a required input in the gathered data is absent and taking an action if a predictive model requires a range of input values that are not available for the particular participant.

3. The method of claim 2 in which taking an action comprises posing a question to the particular participant to solicit a response and complete the required input.

4. The method of claim 2 in which taking an action comprises taking a measurement of the particular participant to complete the required input.

5. The method of claim 1 in which the current intervention is selected independent of a specific instantiation of an interaction associated with capabilities and limitations of a specific device.

6. The method of claim 1 in which the information is retrieved from a content library storing at least one of text, audio, and video.

7. The method of claim 1 in which a content library contains a reference to a specific media item and a corresponding reference to an external resource capable of providing the media item to the participant.

8. The method of claim 1 further comprising determining a set of enrollment questions to present to the particular participant to determine the health and wellness goals for the participant.

9. A method comprising
providing a particular participant, electronically through a user interface, intervention messages that will encourage the particular participant to engage in a selected self-applied current intervention, the intervention messages based on data gathered from a group of participants on successive occasions, the data indicating effectiveness of sequences of self-applied interventions in improving health states of participants who belong to respective groups that share similar characteristics.

10. The method of claim 9 further comprising identifying that a required input in the gathered data is absent and taking an action if a predictive model requires a range of input values that are not available for the particular participant.

11. The method of claim 10 in which taking an action comprises posing a question to the particular participant to solicit a response and complete the required input.

12. The method of claim 10 in which taking an action comprises taking a measurement of the particular participant to complete the required input.

13. The method of claim 9 in which the current intervention is selected independent of a specific instantiation of an interaction associated with the capabilities and limitations of a specific device.

14. The method of claim 9 in which the intervention messages are retrieved from a content library storing at least one of text, audio, and video.

15. The method of claim 9 in which a content library contains a reference to a specific media item and a corresponding reference to an external resource capable of providing the media item to the participant.

16. A method comprising
using a machine learning engine to select, for a current occasion, a current intervention to be self-applied by a particular participant,
the machine learning engine having learned from data gathered from a group of participants on successive occasions, effectiveness of sequences of self-applied interventions in improving health states of participants who belong to respective groups that share similar characteristics,
the current intervention being expected to affect, for the particular participant (i) a behavior, (ii) the health state, or (iii) an health awareness.

17. The method of claim 16 further comprising identifying that a required input in the gathered data is absent and taking an action if a predictive model requires a range of input values that are not available for the particular participant.

18. The method of claim 17 in which taking an action comprises posing a question to the particular participant to solicit a response and complete the required input.

19. The method of claim 17 in which taking an action comprises taking a measurement of the particular participant to complete the required input.

20. The method of claim 16 in which the current intervention is selected independent of a specific instantiation of an interaction associated with capabilities and limitations of a specific device.

21. A system comprising
a processor to, on successive occasions over a period of time, gather measured data and self-reported data that represent a health state of a particular participant in a health goal system,
a machine learning engine configured to use the gathered data to select, for a current occasion, a current intervention to be self-applied by the particular participant,
the machine learning engine having learned from data gathered from a group of participants on successive occasions, effectiveness of sequences of self-applied interventions in improving the health states of participants who belong to respective groups that share similar characteristics,
the current intervention being expected to affect, for the particular participant (i) a behavior, (ii) the health state, or (iii) a health awareness, and
a communications interface configured to electronically provide to a user interface, viewable by the particular participant, information that will encourage the particular participant to engage in the selected self-applied current intervention.

22. The system of claim 21 further comprising identifying that a required input in the gathered data is absent and taking an action if a predictive model requires a range of input values that are not available for the particular participant.

23. The system of claim 22 in which taking an action comprises posing a question to the particular participant to solicit a response and complete the required input.

24. The system of claim 22 in which taking an action comprises taking a measurement of the particular participant to complete the required input.

25. The system of claim 21 in which the current intervention is selected independent of a specific instantiation of an interaction associated with capabilities and limitations of a specific device.

26. The system of claim 21 in which the information is retrieved from a content library storing at least one of text, audio, and video.

27. The system of claim 21 in which a content library contains a reference to a specific media item and a corresponding reference to an external resource capable of providing the media item to the participant.

28. The system of claim 21 further comprising determining a set of enrollment questions to present to the particular participant to determine the health and wellness goals for the participant.

29. A system comprising
a communications interface configured to electronically provide to a user interface, viewable by a particular participant, intervention messages that will encourage the particular participant to engage in a selected self-applied current intervention, the intervention messages based on data gathered from a group of participants on successive occasions, the data indicating effectiveness of sequences of self-applied interventions in improving health states of participants who belong to respective groups that share similar characteristics.

30. The system of claim 29 further comprising identifying that a required input in the gathered data is absent and taking an action if a predictive model requires a range of input values that are not available for the particular participant.

31. The system of claim 30 in which taking an action comprises posing a question to the particular participant to solicit a response and complete the required input.

32. The system of claim 30 in which taking an action comprises taking a measurement of the particular participant to complete the required input.

33. The system of claim 29 in which the current intervention is selected independent of a specific instantiation of an interaction associated with capabilities and limitations of a specific device.

34. The system of claim 29 in which the messages are retrieved from a content library storing at least one of text, audio, and video.

35. The system of claim 29 in which a content library contains a reference to a specific media item and a corresponding reference to an external resource capable of providing the media item to the participant.

36. A system comprising
a machine learning engine configured to select, for a current occasion, a current intervention to be self-applied by a particular participant,
the machine learning engine having learned from data gathered from a group of participants on successive occasions, effectiveness of sequences of self-applied interventions in improving health states of participants who belong to respective groups that share similar characteristics,
the current intervention being expected to affect, for the particular participant (i) a behavior, (ii) the health state, or (iii) a health awareness.

37. The system of claim 36 further comprising identifying that a required input in the gathered data is absent and taking an action if a predictive model requires a range of input values that are not available for the particular participant.

38. The system of claim 37 in which taking an action comprises posing a question to the particular participant to solicit a response and complete the required input.

39. The system of claim 37 in which taking an action comprises taking a measurement of the particular participant to complete the required input.

40. The system of claim 36 in which the current intervention is selected independent of a specific instantiation of an interaction associated with capabilities and limitations of a specific device.
